(19) United States
(12) Patent Application Publication
(10) Pub. No.: US 2026/0156288 A1
(43) Pub. Date: Jun. 4, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zikun YUAN, Beijing (CN); Weijia ZHU, Los Angeles, CA (US); Yuwen HE, Los Angeles, CA (US); Li ZHANG, Los Angeles, CA (US)

(21) Appl. No.: 19/177,466

(22) Filed: Apr. 11, 2025

Related U.S. Application Data
(63) Continuation of application No. PCT/CN2022/125183, filed on Oct. 13, 2022.

(51) Int. Cl. H04N 19/513; H04N 19/105; H04N 19/176; H04N 19/196; H04N 19/53; H04N 19/567; H04N 19/583; H04N 19/82

(52) U.S. Cl. CPC H04N 19/521; H04N 19/105; H04N 19/176; H04N 19/196; H04N 19/53; H04N 19/567; H04N 19/583; H04N 19/82

(57) ABSTRACT

Embodiments of the present disclosure provide a solution for video processing. A method for video processing is proposed. The method comprises: determining, during a conversion between a target block of a video and a bitstream of the target block, a target motion vector from a set of candidate motion vectors based on information of a neighbor block associated with the target block; performing a motion estimation of a filtering process based on the target motion vector, and performing the conversion according to the motion estimation.

### CROSS REFERENCE

This application is a continuation of International Application No. PCT/CN2022/125183, filed on Oct. 13, 2023. The entire contents of these applications are hereby incorporated by reference in their entireties.

### FIELD

Embodiments of the present disclosure relates generally to video coding techniques, and more particularly, to motion compensated temporal filter (MCTF) design in video encoding/decoding.

### BACKGROUND

In nowadays, digital video capabilities are being applied in various aspects of people's' lives. Multiple types of video compression technologies, such as MPEG-2, MPEG-4, ITU-T H.263, ITU-T H.264/MPEG-4 Part 10 Advanced Video Coding (AVC), ITU-T H.265 high efficiency video coding (HEVC) standard, versatile video coding (VVC) standard, have been proposed for video encoding/decoding. However, coding efficiency of conventional video coding techniques is generally low, which is undesirable.

### SUMMARY

Embodiments of the present disclosure provide a solution for video processing.

In a first aspect, a method for video processing is proposed. The method comprises: determining, during a conversion between a target block of a video and a bitstream of the target block, a target motion vector from a set of candidate motion vectors based on information of a neighbor block associated with the target block; performing a motion estimation of a filtering process based on the target motion vector; and performing the conversion according to the motion estimation. Compared with the conventional solution, the proposed method can advantageously improve the coding efficiency and performance.

In a second aspect, another method for video processing is proposed. The method comprises: determining, during a conversion between a target block of a video and a bitstream of the target block, an error that comprises neighboring information of the target block; performing a filtering process based on the error; and performing the conversion according to the filtering process. Compared with the conventional solution, the proposed method can advantageously improve the coding efficiency and performance.

In a third aspect, another method for video processing is proposed. The method comprises: performing, during a conversion between a target block of a video and a bitstream of the target block, a filtering process on a set of overlapped blocks associated with the target block; and performing the conversion according to the filtering process. Compared with the conventional solution, the proposed method can advantageously improve the coding efficiency and performance.

In a fourth aspect, another method for video processing is proposed. The method comprises: determining, during a conversion between a target block of a video and a bitstream of the target block, an encoding manner of a frame associated with the target block based on whether a filtering process is applied to the frame; and performing the conversion based on the determining. Compared with the conventional solution, the proposed method can advantageously improve the coding efficiency and performance.

In a fifth aspect, an apparatus for processing video data is proposed. The apparatus for processing video data comprises a processor and a non-transitory memory with instructions thereon. The instructions, upon execution by the processor, cause the processor to perform a method in accordance with any of the first, second, third, or fourth aspect.

In a sixth aspect, a non-transitory computer-readable storage medium is proposed. The non-transitory computer-readable storage medium stores instructions that cause a processor to perform a method in accordance with any of the first, second, third, or fourth aspect.

In a seventh aspect, a non-transitory computer-readable recording medium is proposed. The non-transitory computer-readable recording medium stores a bitstream of a video which is generated by a method performed by a video processing apparatus. The method comprises: determining a target motion vector from a set of candidate motion vectors based on information of a neighbor block associated with a target block of the video; performing a motion estimation of a filtering process based on the target motion vector; and generating a bitstream of the target block according to the motion estimation.

In an eighth aspect, another method for storing bitstream of a video is proposed. The method comprises: determining a target motion vector from a set of candidate motion vectors based on information of a neighbor block associated with a target block of the video; performing a motion estimation of a filtering process based on the target motion vector; generating a bitstream of the target block according to the motion estimation; and storing the bitstream in a non-transitory computer-readable recording medium.

In a ninth aspect, another non-transitory computer-readable recording medium is proposed. The non-transitory computer-readable recording medium stores a bitstream of a video which is generated by a method performed by a video processing apparatus. The method comprises: determining an error that comprises neighboring information of a target block of a video; performing a filtering process based on the error; and generating a bitstream of the target block according to the filtering process.

In a tenth aspect, another method for storing bitstream of a video is proposed. The method comprises: determining an error that comprises neighboring information of a target block of a video; performing a filtering process based on the error; generating a bitstream of the target block according to the filtering process; and storing the bitstream in a non-transitory computer-readable recording medium.

In an eleventh aspect, another non-transitory computer-readable recording medium is proposed. The non-transitory computer-readable recording medium storing a bitstream of a video which is generated by a method performed by a video processing apparatus. The method comprises: performing a filtering process on a set of overlapped blocks associated with a target block of the video; and generating a bitstream of the target block according to the filtering process.

In a twelfth aspect, another method for storing bitstream of a video is proposed. The method comprises: performing a filtering process on a set of overlapped blocks associated with a target block of the video; generating a bitstream of the target block according to the filtering process; and storing the bitstream in a non-transitory computer-readable recording medium.

In a thirteenth aspect, another non-transitory computer-readable recording medium is proposed. The non-transitory computer-readable recording medium storing a bitstream of a video which is generated by a method performed by a video processing apparatus. The method comprises: determining an encoding manner of a frame associated with a target block of the video based on whether a filtering process is applied to the frame; and generating a bitstream of the target block based on the determining.

In a fourteenth aspect, another method for storing bitstream of a video is proposed. The method comprises: determining an encoding manner of a frame associated with a target block of the video based on whether a filtering process is applied to the frame; generating a bitstream of the target block based on the determining; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is an overview of VVC standard;

FIG. 5 illustrates a schematic diagram of different layers of a hierarchical motion estimation;

FIG. 6 illustrates a schematic diagram of a decoding process with the ACT;

FIG. 7 illustrates an example of a block coded in palette mode;

FIG. 8 illustrates a schematic diagram according to embodiments of the present disclosure;

FIG. 9a shows a motion intensity of optimal MVs obtained by conventional ME and FIG. 9b shows a motion intensity of optimal MVs according to embodiments of the present disclosure;

FIG. 10a shows a result of distribution of errors in the spatial domain according to conventional filtering and FIG. 10b shows a result of distribution of errors in the spatial domain according to embodiments of the present disclosure;

FIG. 11 shows a flowchart of a method according to some embodiments of the present disclosure;

FIG. 12 shows a flowchart of a method according to some embodiments of the present disclosure;

FIG. 13 shows a flowchart of a method according to some embodiments of the present disclosure;

FIG. 14 shows a flowchart of a method according to some embodiments of the present disclosure; and

FIG. 15 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

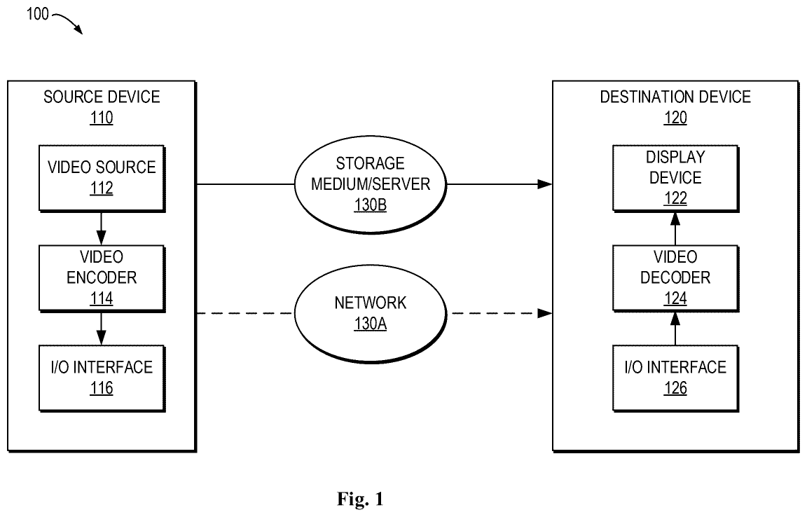

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

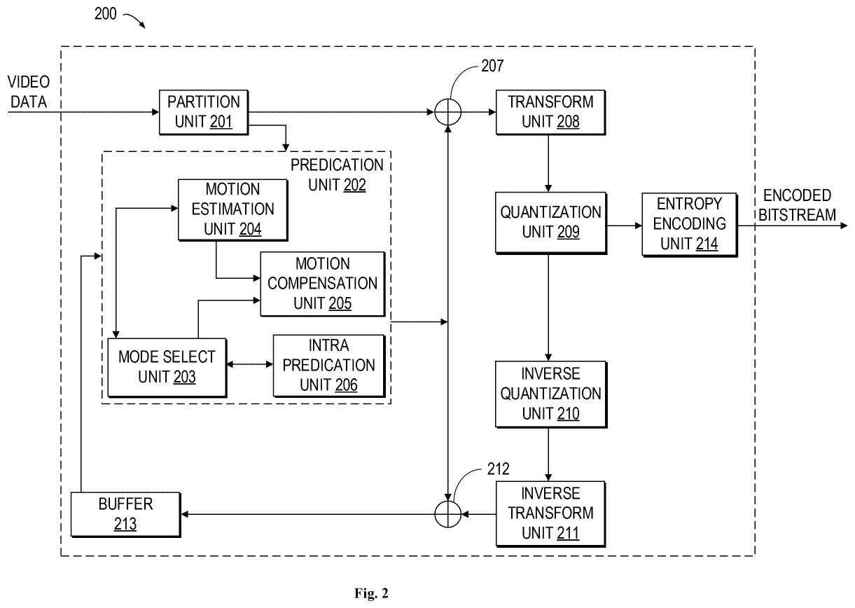

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

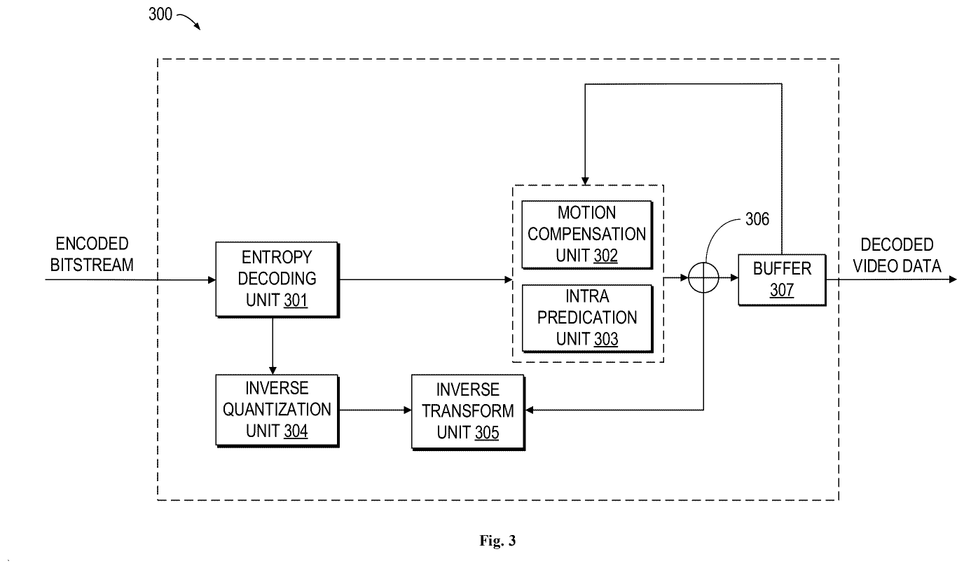

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some example embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 SUMMARY

Embodiments of the present disclosure are related to video encoding technologies. Specifically, it is related to the motion compensated temporal filter (MCTF) design in video encoding. It may be applied to existing video encoders, such as VTM, x264, x265, HM, VVenC and others. It may also be applicable to future video coding encoders or video codecs.

### 2 BACKGROUND

### 2.1 Versatile Video Coding (VVC) Standard

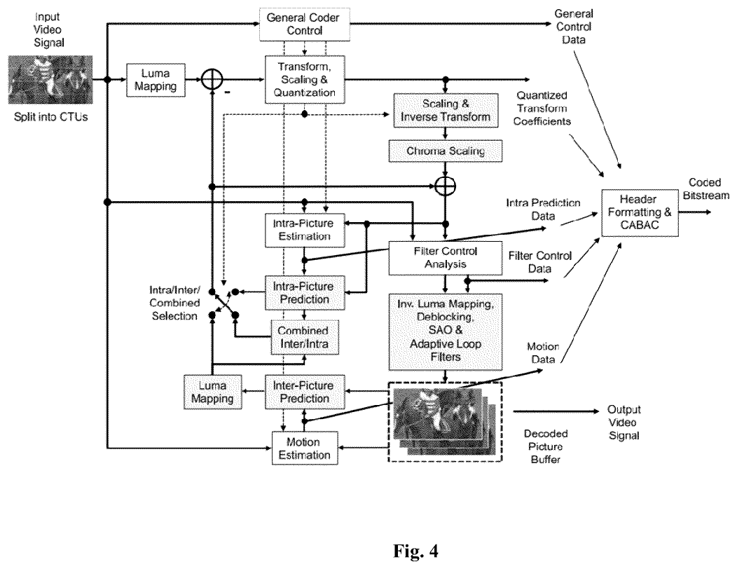

FIG. 4 shows the functional diagram of a typical hybrid VVC encoder, including a block partitioning that splits a video picture into CTUs. For each CTU, quad-tree, triple tree and binary tree structure are employed to partition it into several blocks, called coding units. For each coding unit, block-based intra or inter prediction is performed, then the generated residue is transformed and quantized. Finally, context adaptive binary arithmetic coding (CABAC) entropy coding is employed for bit-stream generation.

### 2.2 MCTF Introduction

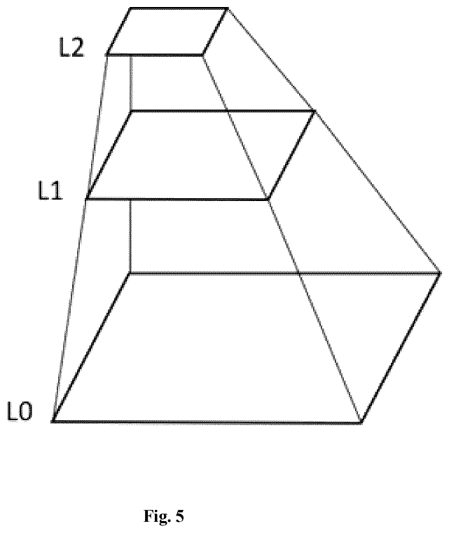

MCTF is a pre filtering process for better compression efficiency. Several encoders, such as VVC test model (VTM) and HEVC test model (HM) support MCTF. And the MCTF is applied prior to the encoding process. In the MCTF, when the reference frames are ready, a hierarchical motion estimation scheme (ME) is used to find the best motion vectors for every 8×8 block. As shown in FIG. 5, three layers are employed in the hierarchical motion estimation scheme. Each sub-sampled layer is half the width, and half the height of the lower layer and sub-sampling is done by computing a rounded average of four corresponding sample values from the lower layer. Different subsampling ratio and subsampling filter may be applied.
The ME process is described as below. First, motion estimation is performed for each 16×16 block in L2. The ME differences (e.g., sum of squared differences) are calculated for each selected motion vector and the motion vector corresponding to the smallest matching difference is selected. The selected motion vector is then used as initial value when estimating the motion in L1. Then the same is done for estimating motion in L0. As a final step, one more integer precision motion and a fractional precision motion are estimated for each 8×8 block. Motion compensation is applied on the pictures before and after the current picture according to the best matching motion for each 8×8 block to align the sample coordinates of each block in the current picture with the best matching coordinates in the referenced pictures.
In the filtering process, MCTF is performed on each 8×8 block. Samples of the current picture are then individually filtered for the luma and chroma channels as follows to produce a filtered picture. The filtered sample value, Iₙ, for the current picture is calculated with the following formula:

$${I}_{n} = \frac{{I}_{o} + {\sum }_{i = - 4}^{4} {w}_{r} ( i , a ) {I}_{r} ( i )}{1 + {\sum }_{i = - 4}^{4} {w}_{r} ( i , a )} \qquad ( 2 - 1 )$$

where Iₒ is the original sample value, Iᵣ(i) is the prediction sample value motion compensated from picture i and wᵣ(i, a) is the weight of motion compensated picture i given a value a. If there is no reference frame coming after the current frame, a is set equal to 1, otherwise, a is equal to 0.
For samples in the luma channel, the weights, wᵣ(i, a), are calculated as follows:

$${w}_{r} ( i , a ) = {s}_{l} {s}_{o} ( n ) {s}_{r} ( i , a ) {w}_{a} {e}^{- \frac{Δ {I ( i )}^{2}}{2 {σ}_{w} {{σ}_{l} ( Q P )}^{2}}} , \qquad ( 2 - 2 )$$

$$where$$

$${s}_{l} = 0.4 ,$$

$${s}_{r} ( i , 4 ) = \{ \begin{matrix}0. , & i = 0 \\ 1.13 , & \vert i \vert = 1 \\ 0.97 , & \vert i \vert = 2 \\ 0.81 , & \vert i \vert = 3 \\ 0.57 , & \vert i \vert = 4\end{matrix} ,$$

$${s}_{r} ( i , 8 ) = \{ \begin{matrix}0. , & i = 0 \\ 0.85 , & \vert i \vert = 1 \\ 0.57 , & \vert i \vert = 2 \\ 0.41 , & \vert i \vert = 3 \\ 0.33 , & \vert i \vert = 4\end{matrix} ,$$

i and a for the remaining cases are:

$${s}_{r} ( i , a ) = 0.3 ,$$

$$and$$

$${σ}_{l} ( Q P ) = 3 * ( Q P - 10 )$$

$$Δ I ( i ) = {I}_{r} ( i ) - {I}_{o} .$$

The adjustment factors wₐ and σ_{w} are calculated for use in computing wᵣ(i, a), as follows:

$${w}_{a} = \frac{min ( error )}{error + 1} \times \{ \begin{matrix}1. if noise < 25 \\ 0.6 else\end{matrix} \times \{ \begin{matrix}0.6 if error > 100 \\ 1. else\end{matrix} \times \{ \begin{matrix}1.2 if error < 50 \\ 1. else\end{matrix} \qquad ( 2 - 3 )$$

where min(error) is the smallest error in the same position of all motion compensated pictures

$${σ}_{w} = \{ \begin{matrix}1. if noise < 25 \\ 0.8 else\end{matrix} \times \{ \begin{matrix}1. if error < 50 \\ 0.8 else\end{matrix} . \qquad ( 2 - 4 )$$

The noise and error values are computed at a block granularity of 8×8 for luma and 4×4 for chroma, are calculated as follows:

$$error = 20 \times \frac{S S E + 5}{{\sum }_{x = 0}^{b s X} {\sum }_{y = 0}^{b s Y} {( {orig}_{x , y} - \frac{1}{b s X \times b s Y} {\sum }_{x = 0}^{b s X} {\sum }_{y = 0}^{b s Y} {orig}_{x , y} )}^{2}} + \frac{S S E}{50 \times b s X \times b s Y} \qquad ( 2 - 5 )$$

$$noise = \frac{15 \times \frac{b s X \times b s Y}{2 \times b s X \times b s Y - b s X - b s Y} \times variance + 5}{diffsum + 5} \qquad ( 2 - 6 )$$

$$where$$

$$variance = {\sum }_{x = 0}^{b s X} {\sum }_{y = 0}^{b s Y} {( o r i {g}_{x , y} - r e {f}_{x , y} )}^{2} \qquad ( 2 - 7 )$$

$$diffsum = {\sum }_{x = 0}^{b s X - 1} {\sum }_{y = 0}^{b s Y - 1} {( ( o r i {g}_{x + 1 , y} - r e {f}_{x + 1 , y} ) - ( o r i {g}_{x , y} - r e {f}_{x , y} ) )}^{2} + {( ( o r i {g}_{x , y + 1} - re {f}_{x , y + 1} ) - ( o r i {g}_{x , y} - r e {f}_{x , y} ) )}^{2} \qquad ( 2 - 8 )$$

bsX and bsY represent the width and height of the block, respectively.
For the chroma channels, the weights, wᵣ(i, a), is calculated as follows:

$${w}_{r} ( i , a ) = {s}_{c} {s}_{o} ( n ) {s}_{r} ( i , a ) {e}^{- \frac{Δ {I ( i )}^{2}}{2 {σ}_{c}^{2}}} \qquad ( 2 - 9 )$$

$$where {s}_{c} = 0.55 and {σ}_{c} = 30 .$$

### 2.3 Transform Skip Mode

The residual of a block can be coded with transform skip mode which completely skip the transform process for a block. In addition, in VVC, for transform skip blocks, a minimum allowed Quantization Parameter (QP) signaled in SPS is used, which is set equal to 6×(internalBitDepth−inputBitDepth)+4 in VTM.

### 2.4 Adaptive Colour Transform (ACT)

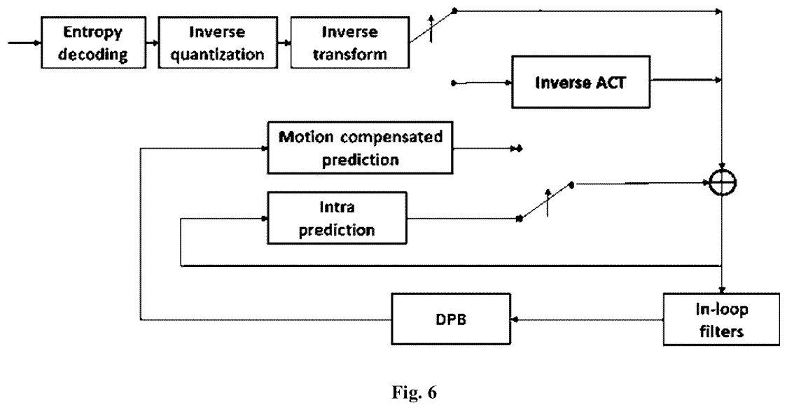

FIG. 6 illustrates the decoding flowchart of VVC with the ACT be applied. As illustrated in FIG. 6, the colour space conversion is carried out in residual domain. Specifically, one additional decoding module, namely inverse ACT, is introduced after inverse transform to convert the residuals from YCgCo domain back to the original domain.
In the VVC, unless the maximum transform size is smaller than the width or height of one coding unit (CU), one CU leaf node is also used as the unit of transform processing. Therefore, in the proposed implementation, the ACT flag is signaled for one CU to select the color space for coding its residuals. Additionally, following the HEVC ACT design, for inter and IBC CUs, the ACT is only enabled when there is at least one non-zero coefficient in the CU. For intra CUs, the ACT is only enabled when chroma components select the same intra prediction mode of luma component, i.e., DM mode.
The core transforms used for the colour space conversions are kept the same as that used for the HEVC. Additionally, same with the ACT design in HEVC, to compensate the dynamic range change of residuals signals before and after colour transform, the QP adjustments of (−5, −5, −3) are applied to the transform residuals.
On the other hand, as shown in FIG. 6, the forward and inverse colour transforms need to access the residuals of all three components. Correspondingly, in the proposed implementation, the ACT is disabled in the following two scenarios where not all residuals of three components are available.
1. Separate-tree partition: when separate-tree is applied, luma and chroma samples inside one CTU are partitioned by different structures. This results in that the CUs in the luma-tree only contains luma component and the CUs in the chroma-tree only contains two chroma components.
2. Intra sub-partition prediction (ISP): the ISP sub-partition is only applied to luma while chroma signals are coded without splitting. In the current ISP design, except the last ISP sub-partitions, the other sub-partitions only contain luma component.

### 2.5 Block-Based Delta Pulse Code Modulation (BDPCM)

In JVET-M0413, a block-based Delta Pulse Code Modulation (BDPCM) is proposed to code screen contents efficiently and then adopted into VVC.

The prediction directions used in BDPCM can be vertical and horizontal prediction modes. The intra prediction is done on the entire block by sample copying in prediction direction (horizontal or vertical prediction) like intra prediction. The residual is quantized and the delta between the quantized residual and its predictor (horizontal or vertical) quantized value is coded. This can be described by the following: For a block of size M (rows)×N (cols), let r_{i,j}, 0≤i≤M−1, 0≤j≤N−1 be the prediction residual after performing intra prediction horizontally (copying left neighbor pixel value across the the predicted block line by line) or vertically (copying top neighbor line to each line in the predicted block) using unfiltered samples from above or left block boundary samples. Let Q(r_{i,j}), 0≤i≤M−1, 0≤j≤N−1 denote the quantized version of the residual r_{i,j}, where residual is difference between original block and the predicted block values. Then the block DPCM is applied to the quantized residual samples, resulting in modified M×N array \tilde{R} with elements \tilde{r}_{i,j}. When vertical BDPCM is signalled:

$${\tilde{r}}_{i , j} = \{ \begin{matrix}Q ( {r}_{i , j} ) , & i = 0 , 0 \leq j \leq ( N - 1 ) \\ Q ( {r}_{i , j} ) - Q ( {r}_{( i - 1 ) , j} ) , & 1 \leq i \leq ( M - 1 ) , 0 \leq j \leq ( N - 1 )\end{matrix} . \qquad ( 2 - 10 )$$

For horizontal prediction, similar rules apply, and the residual quantized samples are obtained by

$${\tilde{r}}_{i , j} = \{ \begin{matrix}Q ( {r}_{i , j} ) , & 0 \leq i \leq ( M - 1 ) , j = 0 \\ Q ( {r}_{i , j} ) - Q ( {r}_{i , ( j - 1 )} ) , & 0 \leq i \leq ( M - 1 ) , 1 \leq j \leq ( N - 1 )\end{matrix} . \qquad ( 2 - 11 )$$

The residual quantized samples \tilde{r}_{i,j} are sent to the decoder.
On the decoder side, the above calculations are reversed to produce Q(r_{i,j}), 0≤i≤M−1, 0≤j≤N−1.
For vertical prediction case,

$$Q ( {r}_{i , j} ) = {\sum }_{k = 0}^{i} {\tilde{r}}_{k , j} , 0 \leq i \leq ( M - 1 ) , 0 \leq j \leq ( N - 1 ) . \qquad ( 2 - 12 )$$

For horizontal case,

$$Q ( {r}_{i , j} ) = {\sum }_{k = 0}^{j} {\tilde{r}}_{i , k} , 0 \leq i \leq ( M - 1 ) , 0 \leq j \leq ( N - 1 ) . \qquad ( 2 - 13 )$$

The inverse quantized residuals, Q⁻¹(Q(r_{i,j})), are added to the intra block prediction values to produce the reconstructed sample values.

The main benefit of this scheme is that the inverse BDPCM can be done on the fly during coefficient parsing simply adding the predictor as the coefficients are parsed or it can be performed after parsing.

In VTM-7.0, the BDPCM also can be applied on chroma blocks and the chroma BDPCM has a separate flag and BDPCM direction from the luma BDPCM mode.

### 2.6 Palette Mode

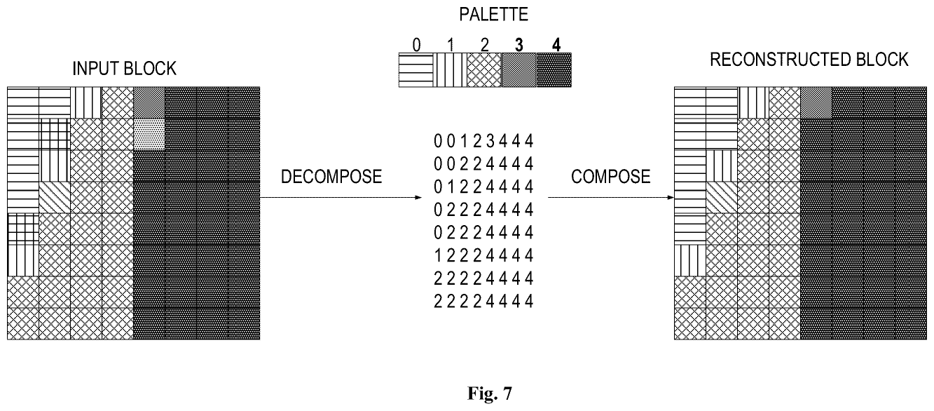

The basic idea behind a palette mode is that the pixels in the CU are represented by a small set of representative colour values. This set is referred to as the palette. And it is also possible to indicate a sample that is outside the palette by signalling an escape symbol followed by (possibly quantized) component values. This kind of pixel is called escape pixel. The palette mode is illustrated in FIG. 7. As depicted in FIG. 7, for each pixel with three coloc components (luma, and two chroma components), an index to the palette is founded, and the block could be reconstructed based on the founded values in the palette.

### 3 PROBLEMS

The current MCTF design has the following problems:
1. It does not include the information of neighboring blocks of a current block in the ME process, thus the MCTF performance is limited due to the inconsistency of motion fields introduced.
2. It does not include the information of neighboring blocks of a current block in the filtering process, the MCTF performance is thus limited due to boundary artifacts of adjacent blocks introduced.
3. The MCTF filters are performed on blocks which are not overlapped, which may affect the MCTF performance since a reference block may cross two filtering blocks in the encoding process.
4. The reference blocks are filtered into current blocks in a frame being filtered by MCTF, the frame needs to be carefully handled to avoid removing the reference blocks components from the frame. The existing coding scheme does not consider this aspect.

### 4 EMBODIMENTS OF THE PRESENT DISCLOSURE

To solve the above problems and some other problems not mentioned, methods as summarized below are disclosed. Embodiments of the present disclosure should be considered as examples to explain the general concepts and should not be interpreted in a narrow way. Furthermore, these inventions can be applied individually or combined in any manner.
It should be noticed that “MCTF” may represent the design in the prior art, alternatively, it could represent any variances of the MCTF design in the prior art or other kinds of temporal filtering methods.

### MCTF ME Process Including Neighboring Information

Let C be a current block. Let Fᵢ be the difference metric, corresponding to a motion vector MVᵢ associated with C, where 1≤i≤L.
Let R be the reference block corresponding to MVᵢ. Let CNⱼ be the j^{th} neighboring block of C. Let RNⱼ be the j^{th} neighboring block of the reference block, where 1≤j≤S.
Let T be the cost between C and R.
Let Kⱼ be the cost between CNⱼ and RNⱼ.
Let mctf_frame be a frame with MCTF applied, let non_mctf_frame be a frame without MCTF applied.
1. The decision of best motion vector in the MCTF ME process may depend on the information of neighboring blocks, e.g., the cost of neighboring blocks.
   a. In one example, the cost of neighbouring blocks may be dependent on a motion vector to be checked in the ME process of the current block.
   b. In one example, the final cost of a motion vector to be checked for current block may be calculated with a linear function of cost associated with current block and neighbouring blocks.
   c. In one example, the final cost of a motion vector to be checked for current block may be calculated with a non-linear function of cost associated with current block and neighbouring blocks.
   d. In the ME process in the MCTF, the ME difference (as described in section 2) may include neighboring information.
   e. In one example, Fᵢ may include T and/or Kⱼ.
      i. In one example, Fᵢ may be evaluated as

$${W}_{0} \times T + {\sum }_{j = 1}^{S} {W}_{j} \times {K}_{j} .$$

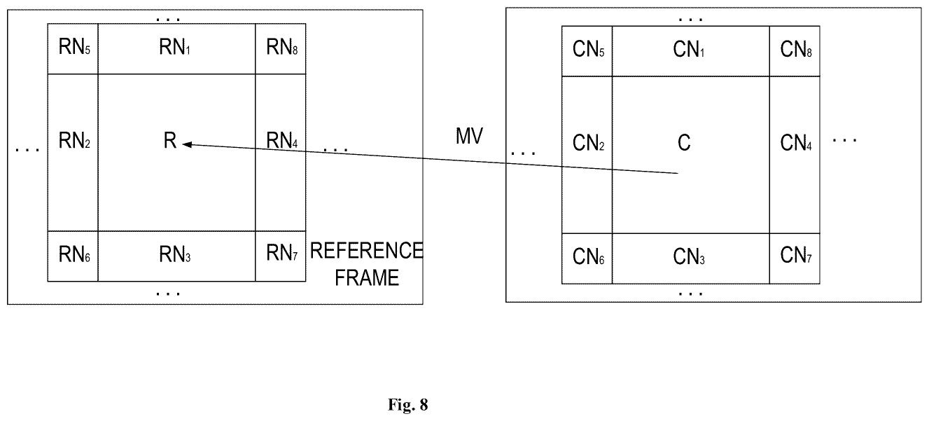

1. In one example, W₀, W₁ . . . Wₛ may have same or different values.
2. In one example, W₁, W₂ . . . Wₛ may have a same value and the value is different from the value of W₀.
ii. In one example, T and/or Kⱼ. may be calculated using a distortion metric, such as sum of absolute differences (SAD), sum of squared error (SSE) or mean sum of squared error (MSE).
f. In one example, CNⱼ and/or RNⱼ may include at least one of the top, bottom, left, right, top-left, top-right, bottom-left and/or bottom right neighboring blocks.
   i. In one example, CNⱼ and/or RNⱼ may include the top, bottom, left, and/or right neighboring blocks.
   ii. In one example, CNⱼ and/or RNⱼ may include the top, left, top-left, and/or top-right neighboring blocks.
   iii. In one example, CNⱼ and/or RNⱼ may include the bottom, right, bottom-right, and/or bottom-left neighboring blocks.
   iv. In one example, CNⱼ and/or RNⱼ may include the top, and/or left neighboring blocks.
   v. In one example, CNⱼ and/or RNⱼ may include the top-left, top-right, bottom-left and/or bottom right neighboring blocks.
   vi. In one example, different block size may be used for different neighboring blocks.
   vii. In one example, the block size of CNⱼ and/or RNⱼ may be identical or different compared to C and R.
   viii. In one example, the size of CNⱼ and/or RNⱼ may be W×H.
   ix. In one example, one or more of W₀, W₁ . . . Wₛ may be determined based on the block size of one or more neighboring blocks.
g. In one example, different methods of introducing neighboring information may be employed for different layers in the hierarchical ME scheme.
   i. In one example, W₀, W₁ . . . Wₛ may be same or different values for different layers in the hierarchical ME.
   ii. In one example, S may be different for different layers in the hierarchical ME.
   iii. In one example, ME with neighboring information is only applied to L1 and L0 layers in the hierarchical ME.
h. In one example, the above bullets may be applied to one or all layers in the hierarchical ME process in the MCTF.
i. In one example, the above bullets may be applied or not applied according to different sized C in the hierarchical ME process in the MCTF.
j. In one example, the above bullets may be illustrated by FIG. 8.

### MCTF Filtering Process Including Neighboring Information

In the following bullets, let MVₖ be the best motion vector for block C. Let R be the reference block corresponding to MVₖ. Let CNⱼ be the j^{th} neighboring block of C. Let RNⱼ be the j^{th} neighboring block of the reference block, where 1≤j≤S.
Let T be the cost between C and R.
Let Kⱼ be the cost between CNⱼ and RNⱼ.
2. In the filter process in the MCTF, the error derived for each filtered block (e.g., as mentioned in section 2) may include neighboring information.
   a. In one example, the neighboring information may be expressed as

$${W}_{0} \times T + {\sum }_{j = 1}^{S} {W}_{j} \times {K}_{j}$$

where 1≤j≤S.
   i. In one example, W₀, W₁ . . . Wₛ may have same or different values.
   ii. In one example, W₁, W₂ . . . Wₛ may have a same value and the value is different from the value of W₀.
   iii. In one example, Kⱼ may be calculated by a distortion metric, such as SAD, SSE or MSE.

### Overlapped MCTF Filtering Process

3. The filtering process in MCTF may be performed on overlapped blocks.
   a. In one example, a width step WS and height step HS may be used, and they may be not equal to the size of a filter block B×B.
   i. In one example, WS and/or HS may be smaller than B.
   ii. In one example, after a block with a position (X, Y) is filtered, the next block to be filter is positioned at (X+WS,Y).
      1. In one example, after all blocks with a vertical position Y are filtered, the next block to be filter is positioned at (X, Y+WS).
   b. In one example, the size of a block to be filtered may be B×B, WS×B, B×HS, WS×HS.
   c. In one example, the error and/or noise for an overlapped region may be determined by involved adjacent blocks.
      i. In one example, the error and/or noise may be calculated by weighting or averaging the errors and/or noises of partial or all involved adjacent blocks.
   d. In one example, the error and/or noise for an overlapped region may use those of one adjacent block.

### MCTF Frames Handling in the Encoding Process

4. How to encode one frame may depend on whether the MCTF is applied to the frame or not.
   a. In one example, one frame after MCTF filtering may be handled in a different way compared to one frame without MCTF filtering in the encoding process.
   b. In one example, the slice/CTU/CU/block level QP of mctf_frame may be decreased or increased by P.
      i. In one example, the above change is only applied to luma QP.
      ii. Alternatively, in one example, the above change is only applied to chroma QP.
      iii. Alternatively, in one example, the above change is applied to both luma and chroma QP.
   c. In one example, the intra cost of partial/all blocks in a mctf_frame may be decreased by Q.
   d. In one example, the skip cost of partial/all blocks in a mctf_frame may be increased by V.
   e. In one example, the coding information F of one or more blocks may be determined differently for mctf_frame and non_mctf_frame.
      i. In one example, F may denote prediction modes.
      ii. Alternatively, in one example, F may denote intra prediction modes.
      iii. Alternatively, in one example, F may denote quad-tree split flags.
      iv. Alternatively, in one example, F may denote binary/ternary tree split types.
      v. Alternatively, in one example, F may denote motion vectors.
      vi. Alternatively, in one example, F may denote merge flag.
      vii. Alternatively, in one example, F may denote merge index.
   f. In one example, whether and/or how to partition a block/region/CTU may be different for mctf_frame and non_mctf_frame.
      i. In one example, the maximum depth of CU in mctf_frame may be increased.
   g. In one example, different motion search methods may be utilized for mctf_frame and non_mctf_frame.
   h. In one example, different fast intra mode algorithms may be utilized for mctf_frame and non_mctf_frame.
   i. In one example, screen content coding tools (e.g., palette mode, IBC mode, BDPCM, ACT and/or transform skip mode) may be not allowed for coding mctf_frame.
   j. In one example, the difference between the MCTF filtered block and the original block may be used as a metric to determine whether the block needs to be handled differently in the encoding or not.
5. The above bullets may be applied in certain conditions.
   a. In one example, the condition is that the distortion of the original pixel and the filtered pixel, including SAD, SSE or MSE, exceeds the threshold X, at the CTU/CU/block level.
   b. In one example the condition is the distortion of the filtered current pixel and the filtered neighboring pixel, including SAD, SSE or MSE, exceeds the threshold Y, at the CTU/CU/block level.
   c. In one example, the condition is one of the values in the average motion vector exceeds the threshold Z, at the slice/CTU/CU/block level.

### General Claim

6. The above bullets could be applied regardless of a current block size used in the MCTF.
   a. In one example, W and/or H may be greater than or equal to 4.
   b. In one example, W and/or H may be smaller than or equal to 64.
   c. In one example, W and/or H may be equal to 8.
7. In the above bullets, W, H, WS, HS, B, P, Q, V, X, Y and/or Z are integer numbers (e.g. 0 or 1) and may depend on:
   a. Slice/tile group type and/or picture type,
   b. Colour component (e.g., may be only applied on Cb or Cr),
   c. Temporal layer ID,
   d. The layer ID in the pyramid ME search,
   e. Profiles/Levels/Tiers of a standard.
8. The above bullets could be applied to MCTF related variances, other filtering methods, like bilateral filters, low-pass filters, and high-pass filters.
9. The above bullets could be applied to in-loop filters.

### 5 EMBODIMENTS

MCTF is based on independent blocks with a fixed size in the process of ME and filtering. Although the independent process between blocks is convenient and effective, it is easy for the ME process to be early terminated at locally optimal MVs and the filtering process to produce a large area of inconsistency, resulting in block boundary artifacts after filtering. The processing method of the independent block will affect the quality of the filtering frame and the coding efficiency after filtering. Therefore, a Spatial Neighbor Information-assisted Motion Compensation Temporal Filter (SNIMCTF) method is proposed to improve the performance of MCTF, including ME and filtering processes.

### 5.1 Spatial Neighbor Information-Assisted Motion Compensation Temporal Filter

Conventional MCTF's ME process uses the SSE of the current block C and the reference block R from its reference picture for motion estimation. This estimation process can efficiently and accurately match the reference block with the least distortion of the current block, but only the information of the current block is considered in the estimation process, and the significance of the current block and the neighboring blocks as a whole is not considered. In the encoding process, the frame after MCTF filtering is referenced by a larger block when being referenced by a subsequent frame, and the filtered frame is also encoded in a larger block, and the size of the larger block is usually larger than the current block. If only the optimal reference of the current block is considered in ME, it is likely to fall into the local optimal solution, resulting in the reduction of subsequent frame references in large blocks and the reduction of the coding efficiency of the current filtered frame. Therefore, it proposes a Spatial Neighbor Information-assisted Motion Estimation (SNIME) method to solve this problem.

As shown in FIG. 8, when SNIME performs motion estimation of the optimal reference block of the current block, the neighboring information is introduced into the estimation process in a weighted manner, which is calculated as:

$$S S {E}_{SNIME} ( C , R ) = {w}_{c} S S E ( C , R ) + {\sum }_{i = 1}^{n} {w}_{i} S S E ( C {N}_{i} , R {N}_{i} ) \qquad ( 5 - 1 )$$

where w_{c} is the weight of the current block, wᵢ is the weight of its neighboring blocks, CNᵢ and RNᵢ represent the i-th spatial neighbor block of the current block and its corresponding reference block, respectively. At different resolutions, the spatial distribution of pixels is different, so the correlation between the current blocks and the neighbor block is not the same. For example, in the 1080p resolution, the current block and surrounding blocks are more closely related, but in the 480p resolution, the current block and surrounding blocks may not have such a strong correlation at all ^{[8]}. The correlation of the current block with neighbor blocks is related to the size of the current block. For example, when the current block size is 8×8, it can be associated with further neighbor information, but when the current block size is 16×16, the range of neighbor information related to the current block will be reduced. Therefore, in the hierarchical ME process of MCTF, the motion estimation of different layers with different resolutions will take different weighting parameters w_{c} and wᵢ, and different size of CNᵢ and RNᵢ.
In the filtering process, the filtering parameters are dynamically set through the implicit information of the current block. The independent setting of block-level filtering parameters does not take into account the correlation between the current block and neighboring information, resulting in inconsistencies in filtering between blocks, thereby degrading the filtering effect. Therefore, a Spatial Neighbor Information-assisted Block-level Filtering (SNIBF) scheme is proposed in this disclosure.
The filtering process of MCTF is expressed by Eq. (2-2), where wₐ and σ_{w} are determined by the error between C and R, which are calculated as Eq. (2-3), Eq. (2-4), Eq. (2-5), and Eq. (2-6). In order to be harmonic with SNIME further, SNIBF replaces the SSE in Eq. (2-5) with Eq. (5-1). After the replacement, neighboring information is considered to the decision of the filtering key factors, and the block-level filtering process is more correlated to improve the overall filtering effect.

### 5.2 Analysis of SNIME and SNIBF

SNIMCTF mainly optimizes the ME and filtering process of MCTF by introducing spatial neighbor information. The following discussions will further demonstrate the effect of SNIMCTF in a visual way.

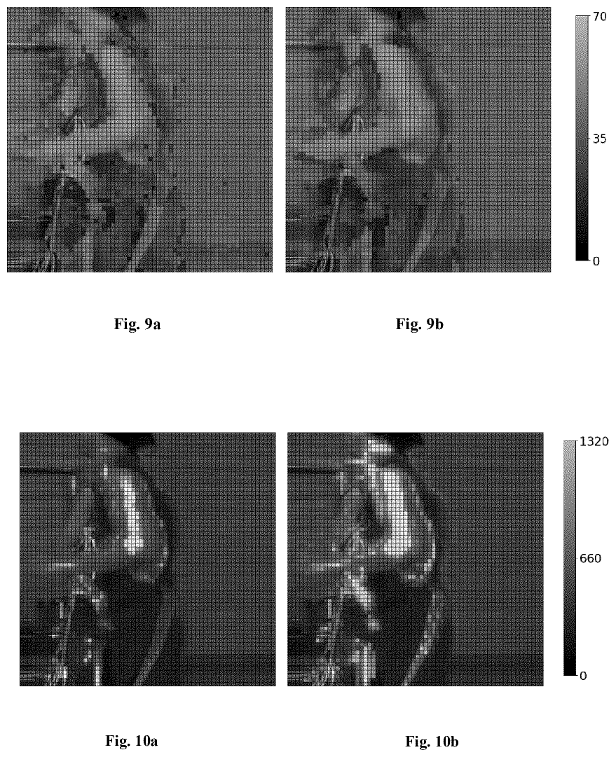

FIGS. 9a and 9b show visualization of the motion intensity of the motion estimation of POCO versus POC2 in 8×8 blocks on an area with coordinates (128, 256) and size (512, 512) of the BasketballDrive under QP15. As shown in FIGS. 9a and 9b, the motion intensity comparison of optimal MVs obtained by conventional ME and SNIME are shown, corresponding to FIGS. 9a and 9b, respectively. The motion intensity in the figure is represented by the absolute value of the maximum value in the motion vector. As readers may observe, there are many areas with strong motion intensity changes in FIG. 9a, but after the spatial neighboring information is introduced in the proposed method, as shown in FIG. 9b, the motion intensity changes become relatively smooth in the spatial domain. This is mainly because adjacent blocks are taken into account when MVs are estimated. In the current design, MVs fall into local optimal regions with only considering the information of a current block. However, the proposed method estimates MVs including more useful information, so it can achieve more optimal MVs then enhances the coding performance.

FIGS. 10a and 10b show visualization of the error of the motion estimation of POCO versus POC2 in 8×8 blocks on an area with coordinates (128, 256) and size (512, 512) of the BasketballDrive under QP15. FIGS. 10a and 10b are the results of the distribution of errors in the spatial domain obtained under conventional filtering and SNIBF. From the visualization results, after employing SNIBF, the error distribution in the spatial domain also becomes more uniform. This error is used to determine the filter coefficients to make the filtering process more consistent between independent blocks.

Embodiments of the present disclosure are related to prediction blended from multiple compositions in image/vide coding.

As used herein, the terms “video unit” or “coding unit” or “block” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block (PB), a transform block (TB), a block, a sub-block of a block, a sub-region within the block, or a region that comprises more than one sample or pixel.

In this present disclosure, regarding “a block coded with mode N”, the term “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, MMVD, BCW, HMVP, SbTMVP, and etc.).

In this context, let C be a current block. Let Fᵢ be the difference metric, corresponding to a motion vector MVᵢ associated with C, where 1≤i≤L. Let R be the reference block corresponding to MVᵢ. Let CNⱼ be the j^{th} neighboring block of C. Let RNⱼ be the j^{th} neighboring block of the reference block, where 1≤j≤S. Let T be the cost between C and R. Let Kⱼ be the cost between CNⱼ and RNⱼ. Let mctf_frame be a frame with MCTF applied, let non_mctf_frame be a frame without MCTF applied. In this context, let MVₖ be the best motion vector for block C. Let R be the reference block corresponding to MVₖ.

It is noted that the terminologies mentioned below are not limited to the specific ones defined in existing standards. Any variance of the coding tool is also applicable.

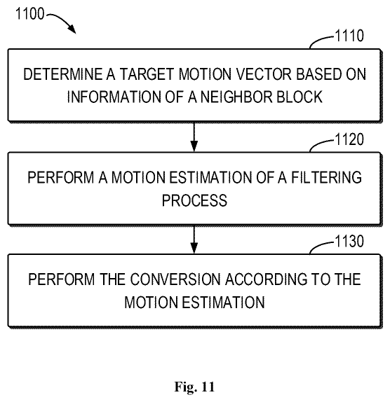

FIG. 11 illustrates a flowchart of a method 1100 for video processing in accordance with some embodiments of the present disclosure. The method 1100 may be implemented during a conversion between a target block and a bitstream of the target block.

As shown in FIG. 11, at block 1110, during a conversion between a target block of a video and a bitstream of the target block, a target motion vector is determined from a set of candidate motion vectors based on information of a neighbor block associated with the target block. In some embodiments, the information of the neighbor block may comprise a cost of the neighbor block. In some embodiments, the cost of the neighbor block may be dependent on a candidate motion vector in the motion estimation of the target block. In one example, a final cost of the candidate motion vector to be checked for the target block may be determined with a linear function of cost associated with the target block and the neighbor block. In another example, the final coast of the candidate motion vector to be checked for the target block may be determined with a non-linear function of coast associated with the target block and the neighbor block.

At block 1120, a motion estimation of a filtering process is performed based on the target motion vector. In some embodiments, in the motion estimation of the filtering process, a motion estimation difference may comprise neighboring information.

At block 1130, the conversion is performed according to the motion estimation. In some embodiments, the conversion may comprise encoding the target block into the bitstream. Alternatively, the conversion may comprise decoding the target block from the bitstream. Compared with the conventional solution, the inconsistency of motion field can be avoided, and the filtering process performance can be improved.

Implementations of the present disclosure can be described in view of the following clauses, the features of which can be combined in any reasonable manner.

In some embodiments, a difference metric of a candidate motion vector may comprise at least one of: a first cost between the target block and a reference block corresponding to the candidate motion vector, or a second cost between a j-th neighbor block of the target block and a j-th neighbor block of the reference block. The j may be an integer. For example, Fᵢ may include T and/or Kⱼ.

In some embodiments, the difference metric Fᵢ may be evaluated as:

$${W}_{0} \times T + {\sum }_{j = 1}^{S} {W}_{j} \times {K}_{j} ,$$

where W0 represents an initial value, Wⱼ represents the j-th value, T represents the first cost, Kⱼ represents the second cost, S represents a total number of neighbor blocks.

In some embodiments, W₀, W₁ . . . Wₛ may have a same value. In some embodiments, W₀, W₁ . . . Wₛ may have different values. In some embodiments, W₁, W₂ . . . Wₛ may have a same value and the value may be different from a value of W₀.

In some embodiments, at least one of: the first cost or the second cost may be determined using a distortion metric. For example, the distortion metric may comprise at least one of: a sum of absolute differences (SAD), a sum of squared error (SSE), or a mean sum of squared error (MSE). In one example, T and/or Kⱼ. may be calculated using a distortion metric, such as sum of absolute differences (SAD), sum of squared error (SSE) or mean sum of squared error (MSE).

In some embodiments, the neighbor block of the target block may comprise at least one of: a top neighbor block of the target block, a bottom neighbor block of the target block, a left neighbor block of the target block, a right neighbor block of the target block, a top-left neighbor block of the target block, a top-right neighbor block of the target block, a bottom-left neighbor block of the target block, or a bottom-right neighbor block of the target block. In some embodiments, a neighbor block of a reference block associated with the target block may comprise at least one of: a top neighbor block of the reference block, a bottom neighbor block of the reference block, a left neighbor block of the reference block, a right neighbor block of the reference block, a top-left neighbor block of the reference block, a top-right neighbor block of the reference block, a bottom-left neighbor block of the reference block, or a bottom-right neighbor block of the reference block. For example, in one example, CNⱼ (for example, CN₁, CN₂, . . . , CN₈ as shown in FIG. 8) and/or RNⱼ (for example, RN₁, RN₂, . . . , RN₈ as shown in FIG. 8) may include the top, bottom, left, and/or right neighboring blocks. In one example, CNⱼ and/or RNⱼ may include the top, left, top-left, and/or top-right neighboring blocks. In one example, CNⱼ and/or RNⱼ may include the bottom, right, bottom-right, and/or bottom-left neighboring blocks. In one example, CNⱼ and/or RNⱼ may include the top, and/or left neighboring blocks. In one example, CNⱼ and/or RNⱼ may include the top-left, top-right, bottom-left and/or bottom right neighboring blocks.

In some embodiments, different block sizes may be used for difference neighboring blocks. In some embodiments, a first block size of the neighbor block may be identical to a second block size of the target block. In some embodiments, the first block size of the neighbor block may be different from the second block size of the target block.

In some embodiments, a third block size of the neighbor block of the reference block may be identical to a fourth block size of the reference block. Alternatively, the third block size of the neighbor block of the reference block may be different from the fourth block size of the reference block. In one example, the block size of CNⱼ and/or RNⱼ may be identical or different compared to C and R.

In some embodiments, a size of the neighbor block may be W×H. In some embodiments, a size of the neighbor block of the reference block may be W×H. In this case, W represents a width of the target block and H represents a height of the target block. In one example, the size of CNⱼ and/or RNⱼ may be W×H. In some embodiments, at least one of: W₀, W₁ . . . Wₛ may be determined based on a block size of one or more neighbor blocks.

In some embodiments, different neighboring information may be employed for different layers in a hierarchical motion estimation scheme. In one example, different methods of introducing neighboring information may be employed for different layers in the hierarchical ME scheme. In one example, W₀, W₁ . . . Wₛ may have a same value for different layers in the hierarchical motion estimation scheme. Alternatively, W₀, W₁ . . . Wₛ may have different values for different layers in the hierarchical motion estimation scheme.

In some embodiments, a total number of neighbor blocks may be different for different layers in the hierarchical motion estimation scheme. In one example, S may be different for different layers in the hierarchical ME.

In some embodiments, the motion estimation with the neighboring information may be applied to L1 and L0 layers in the hierarchical motion estimation scheme. In one example, ME with neighboring information is only applied to L1 and L0 layers in the hierarchical ME.

In some embodiments, determining the target motion vector based on the information of the neighbor may be is applied to at least one layers in a hierarchical motion estimation scheme. For example, the above method or embodiments may be applied to one or all layers in the hierarchical ME process in the MCTF.

In some embodiments, whether determining the target motion vector based on the information of the neighbor block is applied or not may be according to different sizes of the target block in a hierarchical motion estimation scheme in the filtering process. In one example, the above bullets may be applied or not applied according to different sized C in the hierarchical ME process in the MCTF. In some embodiments, the above method or embodiments may be shown in FIG. 8. For example, as shown in FIG. 8, the current block 810 may comprise the neighbor blocks CN₁, CN₂, CN₃, CN₄, CN₅, CN₆, CN₇, and CN₈. The reference block 820 of the current block 810 may comprise the neighbor blocks RN₁, RN₂, RN₃, RN₄, RN₅, RN₆, RN₇, and RN₈.

In some embodiments, a target motion vector from a set of candidate motion vectors may be determined based on information of a neighbor block associated with a target block of the video. In some embodiments, a motion estimation of a filtering process is performed based on the target motion vector. In some embodiments, a bitstream of the target block is generated according to the motion estimation.

In some embodiments, a target motion vector from a set of candidate motion vectors may be determined based on information of a neighbor block associated with a target block of the video. In some embodiments, a motion estimation of a filtering process is performed based on the target motion vector. In some embodiments, a bitstream of the target block is generated according to the motion estimation. In some embodiments, the bitstream is stored in a non-transitory computer-readable recording medium.

FIG. 12 illustrates a flowchart of a method 1200 for video processing in accordance with some embodiments of the present disclosure. The method 1200 may be implemented during a conversion between a target block and a bitstream of the target block.

As shown in FIG. 12, at block 1210, during a conversion between a target block of a video and a bitstream of the target block, an error that comprises neighboring information of the target block is determined. For example, in the filter process in the MCTF, the error derived for each filtered block (e.g., as mentioned in section 2) may include neighboring information.

At block 1220, a filtering process is performed based on the error. At block 1230, the conversion is performed according to the filtering process. In some embodiments, the conversion may comprise encoding the target block into the bitstream. Alternatively, the conversion may comprise decoding the target block from the bitstream. Compared with the conventional solution, the boundary artifacts of adjacent blocks can be avoided, and the filtering process performance can be improved.

Implementations of the present disclosure can be described in view of the following clauses, the features of which can be combined in any reasonable manner.

In some embodiments, the neighboring information may be expressed as:

$${W}_{0} \times T + {\sum }_{j = 1}^{S} {W}_{j} \times {K}_{j} .$$

In this case, W₀ represents an initial value, Wⱼ represents the j-th value, T represents a first cost between the target block and a reference block corresponding to the candidate motion vector, Kⱼ represents a second cost between a j-th neighbor block of the target block and a j-th neighbor block of the reference block, S represents a total number of neighbor blocks, j may be an integer and 1≤j≤S.

In some embodiments, W₀, W₁ . . . Wₛ may have a same value. Alternatively, W₀, W₁ . . . Wₛ may have different values. In some embodiments, W₁, W₂ . . . Wₛ may have a same value and the value may be different from a value of W₀.

In some embodiments, the second cost may be determined using a distortion metric. For example, the distortion metric may comprise at least one of: a sum of absolute differences (SAD), a sum of squared error (SSE), or a mean sum of squared error (MSE). In one example, Kⱼ may be calculated by a distortion metric, such as SAD, SSE or MSE.

In some embodiments, an error that comprises neighboring information of a target block of a video is determined. In some embodiments, a filtering process is performed based on the error. In some embodiments, a bitstream of the target block is generated according to the filtering process.

In some embodiments, an error that comprises neighboring information of a target block of a video is determined. In some embodiments, a filtering process is performed based on the error. In some embodiments, a bitstream of the target block is generated according to the filtering process. In some embodiments, the bitstream is stored in a non-transitory computer-readable recording medium.

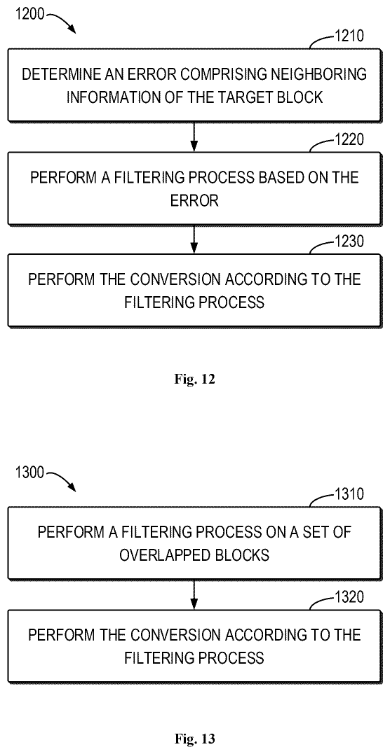

FIG. 13 illustrates a flowchart of a method 1300 for video processing in accordance with some embodiments of the present disclosure. The method 1300 may be implemented during a conversion between a target block and a bitstream of the target block.

As shown in FIG. 13, at block 1310, during a conversion between a target block of a video and a bitstream of the target block, a filtering process is performed on a set of overlapped blocks associated with the target block. For example, the filtering process in MCTF may be performed on overlapped blocks.

At block 1320, the conversion is performed according to the filtering process. In some embodiments, the conversion may comprise encoding the target block into the bitstream. Alternatively, the conversion may comprise decoding the target block from the bitstream. Compared with the conventional solution, the filtering process performance can be improved. For example, if a reference block may cross two filtering blocks in the encoding process, the filter process performance can stilled be guaranteed.

Implementations of the present disclosure can be described in view of the following clauses, the features of which can be combined in any reasonable manner.

In some embodiments, a width step and a height step may be used. For example, the width step and the height step may be different from a size of a filter block. In one example, a width step WS and height step HS may be used, and they may be not equal to the size of a filter block B×B.

In some embodiments, at least one of: the width step or the height step may be smaller than the size of the filter block. In one example, WS and/or HS may be smaller than B.

In some embodiments, after a block with a position (X,Y) is filtered, a next block to be filtered may be at (X+WS, Y). In this case, X presents a horizontal position, Y presents a vertical position, and WS represents the width step.

In some embodiments, after all blocks with a vertical position Y are filtered, a next block to be filtered may be at (X, Y+WS). In this case, X presents a horizontal position, Y presents a vertical position, and WS represents the width step.

In some embodiments, a size of a block to be filtered may be one of: B×B, WS×B, B×HS, or WS×HS, where B represents a size of a filter block, WS represents a width step and HS represents a height step.

In some embodiments, at least one of: an error or a noise for the set of overlapped blocks may be determined based on adjacent blocks. In one example, the error and/or noise for an overlapped region may be determined by involved adjacent blocks. For example, the error for the set of overlapped blocks may be determined by weighting errors of a part of the adjacent blocks or errors of all adjacent blocks. Alternatively, the error for the set of overlapped blocks may be determined by averaging errors of the part of the adjacent blocks or errors of all adjacent blocks. In some embodiments, the noise for the set of overlapped blocks may be determined by weighting noise of a part of the adjacent blocks or noise of all adjacent blocks. Alternatively, the noise for the set of overlapped blocks may be determined by averaging noise of the part of the adjacent blocks or noise of all adjacent blocks. In one example, the error and/or noise may be calculated by weighting or averaging the errors and/or noises of partial or all involved adjacent blocks.

In some embodiments, an error of an adjacent block may be used as an error for the set of overlapped blocks. Alternatively, a noise of the adjacent block may be used as a noise for the set of overlapped blocks. In one example, the error and/or noise for an overlapped region may use those of one adjacent block.

In some embodiments, a filtering process is performed on a set of overlapped blocks associated with a target block of the vide. In some embodiments, a bitstream of the target block is generated according to the filtering process.

In some embodiments, a filtering process is performed on a set of overlapped blocks associated with a target block of the vide. In some embodiments, a bitstream of the target block is generated according to the filtering process. In some embodiments, the bitstream is stored in a non-transitory computer-readable recording medium.

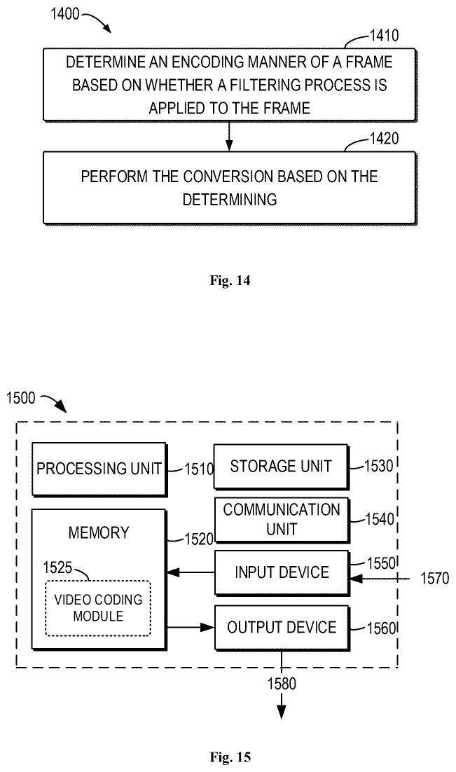

FIG. 14 illustrates a flowchart of a method 1400 for video processing in accordance with some embodiments of the present disclosure. The method 1400 may be implemented during a conversion between a target block and a bitstream of the target block.

As shown in FIG. 14, at block 1410, during a conversion between a target block of a video and a bitstream of the target block, an encoding manner of a frame associated with the target block is determined based on whether a filtering process is applied to the frame. In other words, how to encode one frame may depend on whether the MCTF may be applied to the frame or not.

At block 1420, the conversion is performed based on the determining. In some embodiments, the conversion may comprise encoding the target block into the bitstream. Alternatively, the conversion may comprise decoding the target block from the bitstream. Compared with the conventional solution, it can avoid removing the reference blocks components from the frame.

Implementations of the present disclosure can be described in view of the following clauses, the features of which can be combined in any reasonable manner.

In some embodiments, a frame after the filtering process may be handled in a different way compared to another frame without the filtering process. In some embodiments, at least one of the followings Quantization Parameter (QP) of a frame with the filtering process applied may be in a decreased change or an increased change by P, a slice level, a coding tree unit (CTU) level, a coding unit (CU) level, or a block level. In one example, the slice/CTU/CU/block level QP of mctf_frame may be decreased or increased by P. In this case, P may be any suitable value. For example, P may be an integer or a non-integer. In some embodiments, the decreased change or the increased change may be applied to luma QP. In some embodiments, the decreased change or the increased change may be applied to chroma QP. In some embodiments, the decreased change or the increased change may be applied to both luma QP and chroma QP.

In some embodiments, an intra cost of partial/all blocks in a frame with the filtering process applied may be decreased by Q. In this case, Q may be any suitable value. For example, Q may be an integer or a non-integer. In some embodiments, a skip cost of partial/all blocks in a frame with the filtering process applied may be increased by V. In this case, V may be any suitable value. For example, V may be an integer or a non-integer.

In some embodiments, coding information of at least one block may be determined differently for a frame with the filtering process applied and a frame without the filtering process applied. In some embodiments, the coding information may comprise at least one of: a prediction mode, an intra prediction mode, a quad-tree split flag, a binary tree split type, a ternary tree split type, a motion vector, a merge flag, or a merge index.

In some embodiments, whether and/or how to partition at least one of the followings may be different for a frame with the filtering process applied and a frame without the filtering process applied: a block, a region, or a CTU. In one example, whether and/or how to partition a block/region/CTU may be different for mctf_frame and non_mctf_frame. In some embodiments, a maximum depth of CU in a frame with the filtering process applied may be increased.

In some embodiments, different motion search methods may be utilized for a frame with the filtering process applied and a frame without the filtering process applied. In some embodiments, different fast intra mode algorithms may be utilized for a frame with the filtering process applied and a frame without the filtering process applied.

In some embodiments, a screen content coding tool may not be allowed for coding a frame with the filtering process applied. For example, the screen content coding tool may comprise at least one of: a palette mode, an intra block copy (IBC) mode, a block-based delta pulse code modulation (BDPCM), an adaptive color transform (ACT), or a transform skip mode.

In some embodiments, a difference between a block with the filtering process applied and an original block may be used as a metric to determine whether the block needs to be handled differently in the conversion.

In some embodiments, determining the encoding manner of the frame may be applied in a condition. For example, the condition may be that a distortion of an original pixel and a filtered pixel exceeds a first threshold at one of: CTU level, CU level, or block level. In some embodiments, the condition may be that a distortion of a filtered current pixel and a filtered neighboring pixel exceeds a second threshold at one of: CTU level, CU level, or block level. In some embodiments, the distortion may comprise one of: a SAD, a SSE, or a MSE. In some embodiments, the condition may be one of values in an average motion vector exceeds a third threshold at one of: CTU level, CU level, or block level.

In some embodiments, an encoding manner of a frame associated with a target block of the video is determined based on whether a filtering process is applied to the frame. In some embodiments, a bitstream of the target block is generated based on the determining.

In some embodiments, an encoding manner of a frame associated with a target block of the video is determined based on whether a filtering process is applied to the frame. In some embodiments, a bitstream of the target block is generated based on the determining. In some embodiments, the bitstream is stored in a non-transitory computer-readable recording medium.

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.
Clause 1. A method of video processing, comprising: determining, during a conversion between a target block of a video and a bitstream of the target block, a target motion vector from a set of candidate motion vectors based on information of a neighbor block associated with the target block; performing a motion estimation of a filtering process based on the target motion vector; and performing the conversion according to the motion estimation.
Clause 2. The method of Clause 1, wherein the information of the neighbor block comprises a cost of the neighbor block.
Clause 3. The method of Clause 2, wherein the cost of the neighbor block is dependent on a candidate motion vector in the motion estimation of the target block.
Clause 4. The method of Clause 2, wherein a final cost of the candidate motion vector to be checked for the target block is determined with a linear function of cost associated with the target block and the neighbor block, or wherein the final coast of the candidate motion vector to be checked for the target block is determined with a non-linear function of coast associated with the target block and the neighbor block.
Clause 5. The method of Clause 1, wherein in the motion estimation of the filtering process, a motion estimation difference comprises neighboring information.
Clause 6. The method of Clause 1, wherein a difference metric of a candidate motion vector comprises at least one of: a first cost between the target block and a reference block corresponding to the candidate motion vector, or a second cost between a j-th neighbor block of the target block and a j-th neighbor block of the reference block, and wherein j is an integer.
Clause 7. The method of Clause 6, wherein the difference metric is evaluated as:

$${W}_{0} \times T + {\sum }_{j = 1}^{S} {W}_{j} \times {K}_{j} ,$$

wherein W0 represents an initial value, Wⱼ represents the j-th value, T represents the first cost, Kⱼ represents the second cost, S represents a total number of neighbor blocks.
Clause 8. The method of Clause 7, wherein W₀, W₁ . . . Wₛ have a same value; or wherein W₀, W₁ . . . Wₛ have different values.
Clause 9. The method of Clause 7, wherein W₁, W₂ . . . Wₛ have a same value and the value is different from a value of W₀.
Clause 10. The method of Clause 6, wherein at least one of: the first cost or the second cost is determined using a distortion metric.
Clause 11. The method of Clause 10, wherein the distortion metric comprises at least one of: a sum of absolute differences (SAD), a sum of squared error (SSE), or a mean sum of squared error (MSE).
Clause 12. The method of Clause 1, wherein the neighbor block of the target block comprises at least one of: a top neighbor block of the target block, a bottom neighbor block of the target block, a left neighbor block of the target block, a right neighbor block of the target block, a top-left neighbor block of the target block, a top-right neighbor block of the target block, a bottom-left neighbor block of the target block, or a bottom-right neighbor block of the target block.
Clause 13. The method of Clause 1, wherein a neighbor block of a reference block associated with the target block comprises at least one of: a top neighbor block of the reference block, a bottom neighbor block of the reference block, a left neighbor block of the reference block, a right neighbor block of the reference block, a top-left neighbor block of the reference block, a top-right neighbor block of the reference block, a bottom-left neighbor block of the reference block, or a bottom-right neighbor block of the reference block.
Clause 14. The method of Clause 12 or 13, wherein different block sizes are used for difference neighboring blocks.
Clause 15. The method of Clause 12, wherein a first block size of the neighbor block is identical to a second block size of the target block, or wherein the first block size of the neighbor block is different from the second block size of the target block.
Clause 16. The method of Clause 13, wherein a third block size of the neighbor block of the reference block is identical to a fourth block size of the reference block, or wherein the third block size of the neighbor block of the reference block is different from the fourth block size of the reference block.
Clause 17. The method of Clause 12, wherein a size of the neighbor block is W×H, wherein W represents a width of the target block and H represents a height of the target block.
Clause 18. The method of Clause 13, wherein a size of the neighbor block of the reference block is W×H, wherein W represents a width of the target block and H represents a height of the target block.
Clause 19. The method of Clause 1, wherein at least one of: W₀, W₁ . . . Wₛ is determined based on a block size of one or more neighbor blocks.
Clause 20. The method of Clause 1, wherein different neighboring information is employed for different layers in a hierarchical motion estimation scheme.
Clause 21. The method of Clause 20, wherein W₀, W₁ . . . Wₛ have a same value for different layers in the hierarchical motion estimation scheme, or wherein W₀, W₁ . . . Wₛ have different values for different layers in the hierarchical motion estimation scheme.
Clause 22. The method of Clause 20, wherein a total number of neighbor blocks is different for different layers in the hierarchical motion estimation scheme.
Clause 23. The method of Clause 20, wherein the motion estimation with the neighboring information is applied to L1 and L0 layers in the hierarchical motion estimation scheme.
Clause 24. The method of any of Clauses 1-23, wherein determining the target motion vector based on the information of the neighbor block is applied to at least one layers in a hierarchical motion estimation scheme.
Clause 25. The method of any of Clauses 1-23, wherein whether determining the target motion vector based on the information of the neighbor block is applied or not is according to different sizes of the target block in a hierarchical motion estimation scheme in the filtering process.
Clause 26. A method of video processing, comprising: determining, during a conversion between a target block of a video and a bitstream of the target block, an error that comprises neighboring information of the target block; performing a filtering process based on the error; and performing the conversion according to the filtering process.
Clause 27. The method of Clause 26, wherein the neighboring information is expressed as:

$${W}_{0} \times T + {\sum }_{j = 1}^{S} {W}_{j} \times {K}_{j} ,$$

where W0 represents an initial value, Wⱼ represents the j-th value, T represents a first cost between the target block and a reference block corresponding to the candidate motion vector, Kⱼ represents a second cost between a j-th neighbor block of the target block and a j-th neighbor block of the reference block, S represents a total number of neighbor blocks, j is an integer and 1≤j≤S.
Clause 28. The method of Clause 27, wherein W₀, W₁ . . . Wₛ have a same value; or wherein W₀, W₁ . . . Wₛ have different values.
Clause 29. The method of Clause 27, wherein W₁, W₂ . . . Wₛ have a same value and the value is different from a value of W₀.
Clause 30. The method of Clause 27, wherein the second cost is determined using a distortion metric.
Clause 31. The method of Clause 30, wherein the distortion metric comprises at least one of: a sum of absolute differences (SAD), a sum of squared error (SSE), or a mean sum of squared error (MSE).
Clause 32. A method of video processing, comprising: performing, during a conversion between a target block of a video and a bitstream of the target block, a filtering process on a set of overlapped blocks associated with the target block; and performing the conversion according to the filtering process.
Clause 33. The method of Clause 32, wherein a width step and a height step are used, and wherein the width step and the height step are different from a size of a filter block.
Clause 34. The method of Clause 33, wherein at least one of: the width step or the height step is smaller than the size of the filter block.
Clause 35. The method of Clause 33, wherein after a block with a position (X,Y) is filtered, a next block to be filtered is at (X+WS, Y), wherein X presents a horizontal position, Y presents a vertical position, and WS represents the width step.
Clause 36. The method of Clause 33, wherein after all blocks with a vertical position Y are filtered, a next block to be filtered is at (X, Y+WS), wherein X presents a horizontal position, Y presents a vertical position, and WS represents the width step.
Clause 37. The method of Clause 32, wherein a size of a block to be filtered is one of: B×B, WS×B, B× HS, or WS×HS, wherein B represents a size of a filter block, WS represents a width step and HS represents a height step.
Clause 38. The method of Clause 32, wherein at least one of: an error or a noise for the set of overlapped blocks is determined based on adjacent blocks.
Clause 39. The method of Clause 38, wherein the error for the set of overlapped blocks is determined by weighting errors of a part of the adjacent blocks or errors of all adjacent blocks, or wherein the error for the set of overlapped blocks is determined by averaging errors of the part of the adjacent blocks or errors of all adjacent blocks.
Clause 40. The method of Clause 38, wherein the noise for the set of overlapped blocks is determined by weighting noise of a part of the adjacent blocks or noise of all adjacent blocks, or wherein the noise for the set of overlapped blocks is determined by averaging noise of the part of the adjacent blocks or noise of all adjacent blocks.
Clause 41. The method of Clause 32, wherein an error of an adjacent block is used as an error for the set of overlapped blocks, or wherein a noise of the adjacent block is used as a noise for the set of overlapped blocks.
Clause 42. A method of video processing, comprising: determining, during a conversion between a target block of a video and a bitstream of the target block, an encoding manner of a frame associated with the target block based on whether a filtering process is applied to the frame; and performing the conversion based on the determining.
Clause 43. The method of Clause 42, wherein a frame after the filtering process is handled in a different way compared to another frame without the filtering process.
Clause 44. The method of Clause 42, wherein at least one of the followings Quantization Parameter (QP) of a frame with the filtering process applied is in a decreased change or an increased change by P, a slice level, a coding tree unit (CTU) level, a coding unit (CU) level, or a block level, and wherein P is a value.
Clause 45. The method of Clause 44, wherein the decreased change or the increased change is applied to luma QP, or wherein the decreased change or the increased change is applied to chroma QP, or wherein the decreased change or the increased change is applied to both luma QP and chroma QP.
Clause 46. The method of Clause 42, wherein an intra cost of partial/all blocks in a frame with the filtering process applied is decreased by Q, and wherein Q is a value.
Clause 47. The method of Clause 42, wherein a skip cost of partial/all blocks in a frame with the filtering process applied is increased by V, wherein V is a value.
Clause 48. The method of Clause 42, wherein coding information of at least one block is determined differently for a frame with the filtering process applied and a frame without the filtering process applied.
Clause 49. The method of Clause 48, wherein the coding information comprises at least one of: a prediction mode, an intra prediction mode, a quad-tree split flag, a binary tree split type, a ternary tree split type, a motion vector, a merge flag, or a merge index.
Clause 50. The method of Clause 42, wherein whether and/or how to partition at least one of the followings is different for a frame with the filtering process applied and a frame without the filtering process applied: a block, a region, or a CTU.
Clause 51. The method of Clause 42, wherein a maximum depth of CU in a frame with the filtering process applied is increased.
Clause 52. The method of Clause 42, wherein different motion search methods are utilized for a frame with the filtering process applied and a frame without the filtering process applied.
Clause 53. The method of Clause 42, wherein different fast intra mode algorithms are utilized for a frame with the filtering process applied and a frame without the filtering process applied.
Clause 54. The method of Clause 42, wherein a screen content coding tool is not allowed for coding a frame with the filtering process applied.
Clause 55. The method of Clause 54, wherein the screen content coding tool comprises at least one of: a palette mode, an intra block copy (IBC) mode, a block-based delta pulse code modulation (BDPCM), an adaptive color transform (ACT), or a transform skip mode.
Clause 56. The method of Clause 42, wherein a difference between a block with the filtering process applied and an original block is used as a metric to determine whether the block needs to be handled differently in the conversion.
Clause 57. The method of any of Clauses 42-56, wherein determining the encoding manner of the frame is applied in a condition.
Clause 58. The method of Clause 57, wherein the condition is that a distortion of an original pixel and a filtered pixel exceeds a first threshold at one of: CTU level, CU level, or block level.
Clause 59. The method of Clause 57, wherein the condition is that a distortion of a filtered current pixel and a filtered neighboring pixel exceeds a second threshold at one of: CTU level, CU level, or block level.
Clause 60. The method of Clause 58 or 59, wherein the distortion comprises one of: a SAD, a SSE, or a MSE.
Clause 61. The method of Clause 57, wherein the condition is one of values in an average motion vector exceeds a third threshold at one of: CTU level, CU level, or block level.
Clause 62. The method of any of Clauses 1-61, wherein a block size of the target block used in the filtering process is not considered.
Clause 63. The method of Clause 62, wherein at least one of: a width or a height of the target block is greater than or equal to 4, or wherein at least one of the width or the height of the target block is smaller than or equal to 64, or wherein at least one of the width or the height of the target block is equal to 8.
Clause 64. The method of any of Clauses 1-61, wherein at least one of: a width of the target block, a height of the target block, a width step, a height step, a size of a filter block, P, Q, V, X, Y or Z are integer numbers and depend on: a slice group type, a tile group type, a picture type, a color component, a temporal layer identity, a layer identity in a pyramid motion estimation search, a profile of a standard, a level of the standard, or a tier of the standard.
Clause 65. The method of any of Clauses 1-61, wherein the filtering process comprises at least one of: a motion compensated temporal filter (MCTF), a MCTF related variance, a bilateral filter, a low-pass filter, a high-pass filter, or an in-loop filter.
Clause 66. The method of any of Clauses 1-65, wherein the conversion includes encoding the target block into the bitstream.
Clause 67. The method of any of Clauses 1-65, wherein the conversion includes decoding the target block from the bitstream.
Clause 68. An apparatus for processing video data comprising a processor and a non-transitory memory with instructions thereon, wherein the instructions upon execution by the processor, cause the processor to perform a method in accordance with any of Clauses 1-67.
Clause 69. A non-transitory computer-readable storage medium storing instructions that cause a processor to perform a method in accordance with any of Clauses 1-67.
Clause 70. A non-transitory computer-readable recording medium storing a bitstream of a video which is generated by a method performed by a video processing apparatus, wherein the method comprises: determining a target motion vector from a set of candidate motion vectors based on information of a neighbor block associated with a target block of the video; performing a motion estimation of a filtering process based on the target motion vector; and generating a bitstream of the target block according to the motion estimation.
Clause 71. A method for storing bitstream of a video, comprising: determining a target motion vector from a set of candidate motion vectors based on information of a neighbor block associated with a target block of the video; performing a motion estimation of a filtering process based on the target motion vector; generating a bitstream of the target block according to the motion estimation; and storing the bitstream in a non-transitory computer-readable recording medium.
Clause 72. A non-transitory computer-readable recording medium storing a bitstream of a video which is generated by a method performed by a video processing apparatus, wherein the method comprises: determining an error that comprises neighboring information of a target block of a video; performing a filtering process based on the error; and generating a bitstream of the target block according to the filtering process.
Clause 73. A method for storing bitstream of a video, comprising: determining an error that comprises neighboring information of a target block of a video; performing a filtering process based on the error; generating a bitstream of the target block according to the filtering process; and storing the bitstream in a non-transitory computer-readable recording medium.
Clause 74. A non-transitory computer-readable recording medium storing a bitstream of a video which is generated by a method performed by a video processing apparatus, wherein the method comprises: performing a filtering process on a set of overlapped blocks associated with a target block of the video; and generating a bitstream of the target block according to the filtering process.
Clause 75. A method for storing bitstream of a video, comprising: performing a filtering process on a set of overlapped blocks associated with a target block of the video; generating a bitstream of the target block according to the filtering process; and storing the bitstream in a non-transitory computer-readable recording medium.
Clause 76. A non-transitory computer-readable recording medium storing a bitstream of a video which is generated by a method performed by a video processing apparatus, wherein the method comprises: determining an encoding manner of a frame associated with a target block of the video based on whether a filtering process is applied to the frame; and generating a bitstream of the target block based on the determining.
Clause 77. A method for storing bitstream of a video, comprising: determining an encoding manner of a frame associated with a target block of the video based on whether a filtering process is applied to the frame; generating a bitstream of the target block based on the determining; and storing the bitstream in a non-transitory computer-readable recording medium.

### Example Device

FIG. 15 illustrates a block diagram of a computing device 1500 in which various embodiments of the present disclosure can be implemented. The computing device 1500 may be implemented as or included in the source device 110 (or the video encoder 114 or 200) or the destination device 120 (or the video decoder 124 or 300).

It would be appreciated that the computing device 1500 shown in FIG. 15 is merely for purpose of illustration, without suggesting any limitation to the functions and scopes of the embodiments of the present disclosure in any manner.

As shown in FIG. 15, the computing device 1500 includes a general-purpose computing device 1500. The computing device 1500 may at least comprise one or more processors or processing units 1510, a memory 1520, a storage unit 1530, one or more communication units 1540, one or more input devices 1550, and one or more output devices 1560.

In some embodiments, the computing device 1500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1500 can support any type of interface to a user (such as “wearable” circuitry and the like).

The processing unit 1510 may be a physical or virtual processor and can implement various processes based on programs stored in the memory 1520. In a multi-processor system, multiple processing units execute computer executable instructions in parallel so as to improve the parallel processing capability of the computing device 1500. The processing unit 1510 may also be referred to as a central processing unit (CPU), a microprocessor, a controller or a microcontroller.

The computing device 1500 typically includes various computer storage medium. Such medium can be any medium accessible by the computing device 1500, including, but not limited to, volatile and non-volatile medium, or detachable and non-detachable medium. The memory 1520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1530 may be any detachable or non-detachable medium and may include a machine-readable medium such as a memory, flash memory drive, magnetic disk or another other media, which can be used for storing information and/or data and can be accessed in the computing device 1500.

The computing device 1500 may further include additional detachable/non-detachable, volatile/non-volatile memory medium. Although not shown in FIG. 15, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1540 communicates with a further computing device via the communication medium. In addition, the functions of the components in the computing device 1500 can be implemented by a single computing cluster or multiple computing machines that can communicate via communication connections. Therefore, the computing device 1500 can operate in a networked environment using a logical connection with one or more other servers, networked personal computers (PCs) or further general network nodes.

The input device 1550 may be one or more of a variety of input devices, such as a mouse, keyboard, tracking ball, voice-input device, and the like. The output device 1560 may be one or more of a variety of output devices, such as a display, loudspeaker, printer, and the like. By means of the communication unit 1540, the computing device 1500 can further communicate with one or more external devices (not shown) such as the storage devices and display device, with one or more devices enabling the user to interact with the computing device 1500, or any devices (such as a network card, a modem and the like) enabling the computing device 1500 to communicate with one or more other computing devices, if required. Such communication can be performed via input/output (I/O) interfaces (not shown).

In some embodiments, instead of being integrated in a single device, some or all components of the computing device 1500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1500 may be used to implement video encoding/decoding in embodiments of the present disclosure. The memory 1520 may include one or more video coding modules 1525 having one or more program instructions. These modules are accessible and executable by the processing unit 1510 to perform the functionalities of the various embodiments described herein.

In the example embodiments of performing video encoding, the input device 1550 may receive video data as an input 1570 to be encoded. The video data may be processed, for example, by the video coding module 1525, to generate an encoded bitstream. The encoded bitstream may be provided via the output device 1560 as an output 1580.

In the example embodiments of performing video decoding, the input device 1550 may receive an encoded bitstream as the input 1570. The encoded bitstream may be processed, for example, by the video coding module 1525, to generate decoded video data. The decoded video data may be provided via the output device 1560 as the output 1580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, during a conversion between a target block of a video and a bitstream of the target block, a target motion vector from a set of candidate motion vectors based on information of a neighbor block associated with the target block;
performing a motion estimation of a filtering process based on the target motion vector; and
performing the conversion according to the motion estimation.

2. The method of claim 1, wherein the information of the neighbor block comprises a cost of the neighbor block, and/or
wherein in the motion estimation of the filtering process, a motion estimation difference comprises neighboring information, and/or
wherein a difference metric of a candidate motion vector comprises at least one of: a first cost between the target block and a reference block corresponding to the candidate motion vector, or a second cost between a j-th neighbor block of the target block and a j-th neighbor block of the reference block, and wherein j is an integer, and/or
wherein different neighboring information is employed for different layers in a hierarchical motion estimation scheme.

3. The method of claim 2, wherein the cost of the neighbor block is dependent on a candidate motion vector in the motion estimation of the target block, and/or
wherein a final cost of the candidate motion vector to be checked for the target block is determined with a linear function of cost associated with the target block and the neighbor block, or the final cost of the candidate motion vector to be checked for the target block is determined with a non-linear function of coast associated with the target block and the neighbor block, and/or
wherein the difference metric is evaluated as:
$${W}_{0} \times T + {\sum }_{j = 1}^{S} {W}_{j} \times {K}_{j} ,$$
wherein W₀ represents an initial value, Wⱼ represent j-th initial value, T represents the first cost, Kⱼ represents the second cost, S represents a total number of neighbor blocks, and wherein j is an integer, and/or
wherein at least one of: the first cost or the second cost is determined using a distortion metric, and/or
wherein a total number of neighbor blocks is different for different layers in the hierarchical motion estimation scheme, and/or
wherein the motion estimation with the neighboring information is applied to L1 and L0 layers in the hierarchical motion estimation scheme.

4. The method of claim 1, wherein the neighbor block of the target block comprises at least one of: a top neighbor block of the target block, a bottom neighbor block of the target block, a left neighbor block of the target block, a right neighbor block of the target block, a top-left neighbor block of the target block, a top-right neighbor block of the target block, a bottom-left neighbor block of the target block, or a bottom-right neighbor block of the target block, and/or
wherein a neighbor block of a reference block associated with the target block comprises at least one of: a top neighbor block of the reference block, a bottom neighbor block of the reference block, a left neighbor block of the reference block, a right neighbor block of the reference block, a top-left neighbor block of the reference block, a top-right neighbor block of the reference block, a bottom-left neighbor block of the reference block, or a bottom-right neighbor block of the reference block.

5. The method of claim 4, wherein different block sizes are used for difference neighboring blocks, and/or
wherein a first block size of the neighbor block is identical to a second block size of the target block, or the first block size of the neighbor block is different from the second block size of the target block, and/or
wherein a third block size of the neighbor block of the reference block is identical to a fourth block size of the reference block, or the third block size of the neighbor block of the reference block is different from the fourth block size of the reference block, and/or
wherein a size of the neighbor block is W×H, wherein W represents a width of the target block and H represents a height of the target block, and/or
wherein a size of the neighbor block of the reference block is W×H, wherein W represents a width of the target block and H represents a height of the target block.

6. The method of claim 1, wherein determining the target motion vector based on the information of the neighbor block is applied to at least one layers in a hierarchical motion estimation scheme, and/or
wherein whether determining the target motion vector based on the information of the neighbor block is applied or not is according to different sizes of the target block in a hierarchical motion estimation scheme in the filtering process.

7. The method of claim 1, wherein an error that comprises neighboring information of the target block is determined and the filtering process is performed based on the error.

8. The method of claim 7, wherein the neighboring information is expressed as:
$${W}_{0} \times T + {\sum }_{j = 1}^{S} {W}_{j} \times {K}_{j} ,$$
wherein W₀ represents an initial value, Wⱼ represent j-th initial value, T represents a first cost between the target block and a reference block corresponding to the candidate motion vector, Kⱼ represents a second cost between a j-th neighbor block of the target block and a j-th neighbor block of the reference block, S represents a total number of neighbor blocks, j is an integer and 1≤j≤S.

9. The method of claim 1, wherein the filtering process is performed on a set of overlapped blocks associated with the target block.

10. The method of claim 9, wherein a width step and a height step are used, and the width step and the height step are different from a size of a filter block, and/or
wherein a size of a block to be filtered is one of: B×B, WS×B, B×HS, or WS×HS, wherein B represents a size of a filter block, WS represents a width step and HS represents a height step, and/or
wherein at least one of: an error or a noise for the set of overlapped blocks is determined based on adjacent blocks, or
wherein an error of an adjacent block is used as an error for the set of overlapped blocks, or a noise of the adjacent block is used as a noise for the set of overlapped blocks.

11. The method of claim 10, wherein at least one of: the width step or the height step is smaller than the size of the filter block, and/or
wherein after a block with a position (X,Y) is filtered, a next block to be filtered is at (X+WS, Y), wherein X presents a horizontal position, Y presents a vertical position, and WS represents the width step, and/or
wherein after all blocks with a vertical position Y are filtered, a next block to be filtered is at (X, Y+WS), wherein X presents a horizontal position, Y presents a vertical position, and WS represents the width step, and/or
wherein the error for the set of overlapped blocks is determined by weighting errors of a part of the adjacent blocks or errors of all adjacent blocks, or the error for the set of overlapped blocks is determined by averaging errors of the part of the adjacent blocks or errors of all adjacent blocks, and/or
wherein the noise for the set of overlapped blocks is determined by weighting noise of a part of the adjacent blocks or noise of all adjacent blocks, or the noise for the set of overlapped blocks is determined by averaging noise of the part of the adjacent blocks or noise of all adjacent blocks.

12. The method of claim 1, wherein an encoding manner of a frame associated with the target block is determined based on whether the filtering process is applied to the frame.

13. The method of claim 12, wherein a frame after the filtering process is handled in a different way compared to another frame without the filtering process, and/or
wherein at least one of the followings Quantization Parameter (QP) of a frame with the filtering process applied is in a decreased change or an increased change by a value P: a slice level, a coding tree unit (CTU) level, a coding unit (CU) level, or a block level, and/or
wherein an intra cost of partial/all blocks in a frame with the filtering process applied is decreased by a value Q, and/or
wherein a skip cost of partial/all blocks in a frame with the filtering process applied is increased by a value V, and/or
wherein coding information of at least one block is determined differently for a frame with the filtering process applied and a frame without the filtering process applied, and/or
wherein whether and/or how to partition at least one of the followings is different for a frame with the filtering process applied and a frame without the filtering process applied: a block, a region, or a CTU, and/or
wherein a maximum depth of CU in a frame with the filtering process applied is increased, and/or
wherein different motion search methods are utilized for a frame with the filtering process applied and a frame without the filtering process applied, and/or
wherein different fast intra mode algorithms are utilized for a frame with the filtering process applied and a frame without the filtering process applied, and/or
wherein a screen content coding tool is not allowed for coding a frame with the filtering process applied, and/or
wherein a difference between a block with the filtering process applied and an original block is used as a metric to determine whether the block needs to be handled differently in the conversion, and/wherein determining the encoding manner of the frame is applied in a condition.

14. The method of claim 13, wherein the decreased change or the increased change is applied to luma QP, or the decreased change or the increased change is applied to chroma QP, or the decreased change or the increased change is applied to both luma QP and chroma QP, and/or
wherein the coding information comprises at least one of: a prediction mode, an intra prediction mode, a quad-tree split flag, a binary tree split type, a ternary tree split type, a motion vector, a merge flag, or a merge index, and/or
wherein the screen content coding tool comprises at least one of: a palette mode, an intra block copy (IBC) mode, a block-based delta pulse code modulation (BDPCM), an adaptive color transform (ACT), or a transform skip mode, and/or
wherein the condition is that a distortion of an original pixel and a filtered pixel exceeds a first threshold at one of: CTU level, CU level, or block level, and/or
wherein the condition is that a distortion of a filtered current pixel and a filtered neighboring pixel exceeds a second threshold at one of: CTU level, CU level, or block level, and/or
wherein the condition is one of values in an average motion vector exceeds a third threshold at one of: CTU level, CU level, or block level.

15. The method of claim 1, wherein a block size of the target block used in the filtering process is not considered, or
wherein at least one of: a width of the target block, a height of the target block, a width step, a height step, a size of a filter block, P, Q, V, X,Y or Z are integer numbers and depend on:
a slice group type,
a tile group type,
a picture type,
a color component,
a temporal layer identity,
a layer identity in a pyramid motion estimation search,
a profile of a standard,
a level of the standard, or
a tier of the standard.

16. The method of claim 1, wherein the filtering process comprises at least one of:
a motion compensated temporal filter (MCTF),
a MCTF related variance,
a bilateral filter,
a low-pass filter,
a high-pass filter, or
an in-loop filter.

17. The method of claim 1, wherein the conversion includes encoding the target block into the bitstream, and/or
wherein the conversion includes decoding the target block from the bitstream.

18. An apparatus for processing video data comprising a processor and a non-transitory memory with instructions thereon, wherein the instructions upon execution by the processor, cause the processor to:
determine, during a conversion between a target block of a video and a bitstream of the video, a target motion vector from a set of candidate motion vectors based on information of a neighbor block associated with the target block;
perform a motion estimation of a filtering process based on the target motion vector; and
performing the conversion according to the motion estimation.

19. A non-transitory computer-readable storage medium storing instructions that cause a processor to:
determine, during a conversion between a target block of a video and a bitstream of the video, a target motion vector from a set of candidate motion vectors based on information of a neighbor block associated with the target block;
perform a motion estimation of a filtering process based on the target motion vector; and
performing the conversion according to the motion estimation.

20. A non-transitory computer-readable recording medium storing a bitstream of a video which is generated by a method performed by a video processing apparatus, wherein the method comprises:
determining a target motion vector from a set of candidate motion vectors based on information of a neighbor block associated with a target block of the video;
performing a motion estimation of a filtering process based on the target motion vector; and
generating a bitstream of the target block according to the motion estimation.
